(19) United States
(12) Patent Application Publication
(10) Pub. No.: US 2020/0001254 A1
(43) Pub. Date: Jan. 2, 2020

(54) BEARINGLESS HYDRAULIC ROTARY STIRRING WATER DISTRIBUTOR

(71) Applicant: ENERGY RESEARCH INSTITUTE OF JIANGXI ACADEMY OF SCIENCES, NANCHANG CITY (CN)

(72) Inventors: JIUJIU WU, NANCHANG CITY (CN); JIHAI XIONG, NANCHANG CITY (CN); SONG XIA, NANCHANG CITY (CN); SHUANGLIN GUI, NANCHANG CITY (CN); QIZHEN YI, NANCHANG CITY (CN)

(21) Appl. No.: 16/454,960

(22) Filed: Jun. 27, 2019

(30) Foreign Application Priority Data
Jul. 2, 2018 (CN) 201810705337.0

(51) Int. Cl. B01F 7/20; B01F 7/00; C02F 1/00; C02F 3/00

(52) U.S. Cl. CPC B01F 7/20; B01F 7/007; B01F 7/0025; B01F 2215/0422; C02F 1/006; C02F 3/00; B01F 2215/0052; B01F 7/00125

(57) ABSTRACT

Some embodiments of the disclosure provide systems and methods for a bearingless hydraulic rotary stirring water distributor. According to an embodiment, the bearingless hydraulic rotary stirring water distributor includes a rotary inlet pipe, stirring pipes, water distribution pipes, a ball head shaft, a fixed inlet pipe, a bowl seat, a first seal ring, and a second seal ring. The stirring water distributor is vertically mounted, the fixed inlet pipe is vertically arranged and inserted into the rotary inlet pipe, the fixed inlet pipe and the rotary inlet pipe are mechanically sealed through the seal rings therebetween, the rotary inlet pipe is a vertically mounted pipe, and the rotary inlet pipe is vertically mounted in a semispherical groove of the bowl seat through the ball head shaft mounted at one end of the rotary inlet pipe.

### CROSS REFERENCE TO RELATED APPLICATIONS

This application claims priority to Chinese application number 20181070533-7.0 filed on Jul. 2, 2018, the disclosure of which is incorporated by reference herein in its entirety.

### FIELD OF THE DISCLOSURE

The disclosure relates generally to the field of sewage treatment. More specifically, the disclosure relates to the field of a bearingless hydraulic rotary stirring water distributor.

### BACKGROUND

As society develops, the environment-compliant requirements grow higher. The sewage discharge standard becomes more rigorous. The biological treatment equipment and technology for wastewater are continuously improved while the wastewater treatment technology is continuously developed. One significant aspect for improving the capability and the quality of the biological treatment equipment is that the water-distributing and stirring uniformity of the biological treatment equipment should be improved to ensure that the microbial sludge can be fully in contact with the organic matters in water, thereby improving the mass transfer effect.

The traditional water distributor mostly utilizes a lattice type water distribution manner as the main water distribution manner, that is, one point serves one corresponding area; stirring under the impact force of water is achieved by utilizing the power of water feeding, but such impact force of water is limited, or water inflowing rate and quantity are fluctuated, so the water distribution will not be uniform; besides, a junction between an area served by one point and an area served by another point will generate a dead area, in which the stirring is not achieved, the stirring capability and mixing capability of such water distribution are weak, and such water distribution is a local behavior to a reactor, so excellent stirring water distribution effect cannot be achieved, and the treatment capability and the treatment quality of the biological treatment equipment cannot be improved. Additionally, the mechanical stirrer only has a stirring function and does not have a water distribution function, and after it is used for a long time, its shafts and bearings will generate mechanical faults such as dead lock and the like, so the functions of the biological treatment equipment are reduced.

### SUMMARY

The following presents a simplified summary of the invention in order to provide a basic understanding of some aspects of the invention. This summary is not an extensive overview of the invention. It is not intended to identify critical elements or to delineate the scope of the invention. Its sole purpose is to present some concepts of the invention in a simplified form as a prelude to the more detailed description that is presented elsewhere.

In some embodiments, the disclosure provides a bearingless hydraulic rotary stirring water distributor.

According to an embodiment, a bearingless hydraulic rotary stirring water distributor comprises a rotary inlet pipe, stirring pipes, water distribution pipes, a ball head shaft, a fixed inlet pipe, a bowl seat and seal rings. The stirring water distributor is vertically mounted. The fixed inlet pipe is vertically arranged and inserted into the rotary inlet pipe. The fixed inlet pipe and the rotary inlet pipe are mechanically sealed through the seal rings therebetween. The rotary inlet pipe is a vertically mounted pipe and is vertically mounted in a semispherical groove of the bowl seat through the ball head shaft mounted at one end of the rotary inlet pipe. The rotary inlet pipe rotatably runs around the fixed inlet pipe and the ball head shaft under the support of the bowl seat. The stirring pipes are mounted horizontally on the two sides of the lower part of the rotary inlet pipe, and the two stirring pipes are symmetric by taking the center line of the rotary inlet pipe as the axis of symmetry. One end of each stirring pipe is vertically communicated with the rotary inlet pipe, and the opening of the other end of each stirring pipe is closed by a stop plate. Ends of the two stirring pipes close to the stop plates are respectively provided with at least one water distribution pipe. The water distribution pipes on the two stirring pipes are located on the same horizontal plane, and have opposite water discharging directions.

According to another embodiment, the water distribution pipes are perpendicular to the stirring pipes.

According to a further embodiment, the ball head shaft is composed of a circular shaft and a ball head, and the circular shaft is fixed on the ball head through a welding manner or through threads and is also formed by one-time turning processing; the outer diameter of the circular shaft and the inner diameter of the rotary inlet pipe are in an interference fit; and the outer diameter of the ball head is smaller than the inner diameter of the semispherical groove of the bowl seat.

In some embodiments, the rotary inlet pipe, the stirring pipes, and the water distribution pipes are in communication with each other. Water is fed into the rotary inlet pipe through the fixed inlet pipe and then discharged through the water distribution pipes.

In some other embodiments, the number of the water distribution pipes on each stirring pipe is more than one.

In some further embodiments, a vertical inclination angle between the axial line of the rotary inlet pipe and the axial line of the ball head shaft is smaller than 3 degrees.

According to an embodiment, the axial line of the fixed inlet pipe, the axial line of the rotary inlet pipe and the center line of the semispherical groove of the bowl seat coincide; and a gap between the fixed inlet pipe and the rotary inlet pipe is sealed by the seal rings.

According to another embodiment, the length of each stirring pipe, the inclination angle between each water distribution pipe and the horizontal plane and the water discharging direction of each water distribution pipe are manipulated in order to achieve a stable running and optimal stirring effects.

According to a further embodiment, a bearingless hydraulic rotary stirring water distributor takes the water discharging reacting force of the water distribution pipes as the power to drive the stirring pipes to move in an opposite direction of the water discharging direction to achieve uniform water distribution and mechanical stirring. When wastewater is fed into the rotary inlet pipe through the fixed inlet pipe, the wastewater respectively enters the stirring pipes on the two sides through the rotary inlet pipe and then are respectively discharged from the water distribution pipes at the end parts of the stirring pipes on the two sides. The wastewater discharged from the water distribution pipes generate a recoil force to the stirring pipes so that the stirring pipes drive the rotary inlet pipe to rotate in a counter-clockwise direction. The ball head shaft is mounted at the end part of the rotary inlet pipe, and the contact between the ball head and the semispherical groove of the bowl seat is point contact to generate an extremely small friction force, thereby operating the hydraulic rotary stirring water distributor under a bearingless state.

Some of embodiments of the disclosure may have one or more of the following effects: the bearingless hydraulic rotary stirring water distributor is a mechanical stirrer which may generate rotary stirring under a hydraulic action; it adopts two mechanical seals which may solve a leakage problem during mechanical movement; it adopts a support structure of the ball head shaft and the bowl seat which may control the position of the ball head shaft and solves the stress stability; and the ball head shaft and the bowl seat are in point contact and run in a sliding state which may ensure no faults (such as dead lock) arise even if the system keeps running for a long time. The stirring pipes rotate along with the rotary inlet pipe which may achieve a mechanical stirring function, and the water distribution pipes rotate along with the stirring pipes which may achieve movable water distribution and a uniform water distribution effect. Furthermore, the bearingless hydraulic rotary stirring water distributor may have a simple design structure and may be convenient to mount without further maintenance

### BRIEF DESCRIPTION OF THE DRAWINGS

FIG. 1 is a structural schematic diagram of a bearingless hydraulic rotary stirring water distributor provided by the disclosure.

FIG.2 is a top view of FIG. 1.

### DETAILED DESCRIPTION

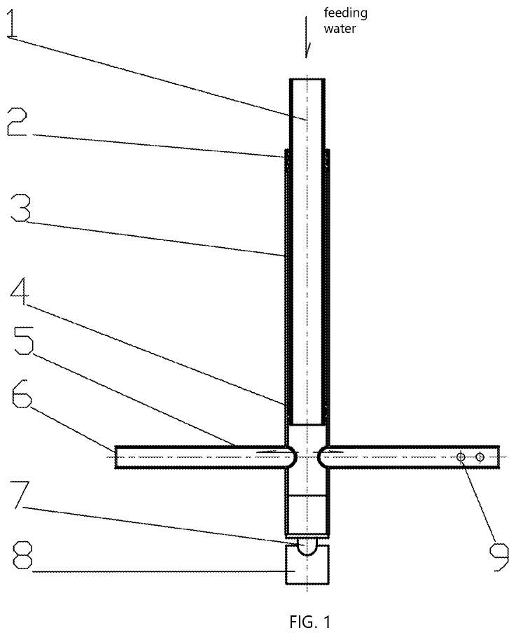

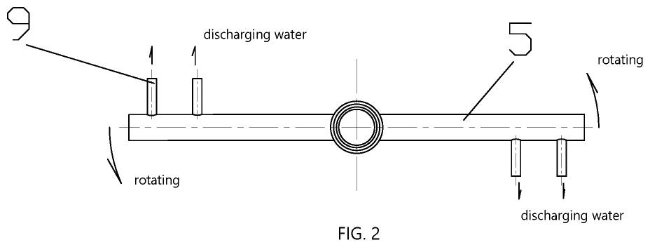

The following describes multiple exemplary embodiments of the disclosure with reference to the accompanying drawings. In FIGS. 1-2, 1 represents a fixed inlet pipe, 2 represents a first seal ring, 3 represents a rotary inlet pipe, 4 represents a second seal ring, 5 represents a stirring pipe, 6 represents a stop plate, 7 represents a ball head shaft, 8 represents a bowl seat, and 9 represents a water distribution pipe.

According to some embodiments, a bearingless hydraulic rotary stirring water distributor includes a rotary inlet pipe 3, stirring pipes 5, water distribution pipes 9, a ball head shaft 7, a fixed inlet pipe 1, a bowl seat 8, a first seal ring 2, and a second seal ring 4, as shown in FIG. 1.

In FIG. 1, the stirring water distributor is vertically mounted. The fixed inlet pipe 1 is vertically arranged and inserted into the rotary inlet pipe 3, the fixed inlet pipe 1 and the rotary inlet pipe 3 are mechanically sealed through the first seal ring 2 and the second seal ring 4 up and down; the rotary inlet pipe 3 is a vertically mounted pipe and is vertically mounted in a semispherical groove of the bowl seat 8 through the ball head shaft 7 mounted at one end of the rotary inlet pipe 3; the stirring pipes 5 are mounted horizontally on the two sides of the lower part of the rotary inlet pipe 3, and the two stirring pipes 5 are symmetric by taking the center line of the rotary inlet pipe 3 as the axis of symmetry; one end of each stirring pipe 5 is vertically communicated with the rotary inlet pipe 3, and the opening of the other end of each stirring pipe 5 is closed by a stop plate 6; ends, close to the stop plates 6, of the two stirring pipes 5 are respectively provided with two water distribution pipes 9, and the water distribution pipes 9 on the two stirring pipes 5 are located on the same horizontal plane, and have opposite water discharging directions.

The following describes an embodiment of an exemplary mounting process of a bearingless hydraulic rotary stirring water distributor. Firstly, the bowl seat 8 is fixedly mounted at the bottom center of a reactor, and the rotary inlet pipe 3 and components of the ball head shaft 7 are fixed on the bowl seat 8 through clamps. Secondly, after the fixed inlet pipe 1 with the first seal ring 2 and the second seal ring 4 is inserted into the rotary inlet pipe 3, the fixed inlet pipe 1 is mounted and fixed properly, and at this time, the clamps for the rotary inlet pipe 3 and the components of the ball head shaft 7 may be removed. Lastly, the stirring pipes 5 and the water distribution pipes 9 may be welded on the rotary inlet pipe 3 one by one.

When the fixed inlet pipe 1 is inserted into the rotary inlet pipe 3, the axial line of the fixed inlet pipe 1 and the axial line of the rotary inlet pipe 2 may coincide. The rotary inlet pipe 3 and the ball head shaft 7 may be mounted vertical to the horizontal plane under the support of the bowl seat 8. The vertical inclination angle between the axial line of the rotary inlet pipe 3 and the ball head shaft 7 may be smaller than 3 degrees.

In the designing process, according to the size and the requirements of the bioreactor, the length and the vertical angle of each stirring pipe 5, and the water discharging direction of each water distribution pipe 9 may be manipulated in order to achieve a stable running and optimal stirring effects.

When the reactor is relatively small, the number of the water distribution pipes 9 on each stirring pipe 5 may be one. When the reactor is relatively large, the number of the water distribution pipes 9 on each stirring pipe 5 may be two or more than two on the premise of ensuring the water distribution uniformity; and the stirring pipes 5 may be angularly mounted in the vertical direction according to requirements of the stirring conditions on the premise of ensuring the stirring uniformity.

In an exemplary embodiment, the disclosure provides a bearingless hydraulic rotary stirring water distributor including a rotary inlet pipe (3), stirring pipes (5), water distribution pipes (9), a ball head shaft (7), a fixed inlet pipe (1), a bowl seat (8), a first seal ring (2), and a second seal ring (4). The fixed inlet pipe is vertically arranged and inserted into the rotary inlet pipe, and the fixed inlet pipe and the rotary inlet pipe are mechanically sealed through the seal rings therebetween. The rotary inlet pipe is vertically mounted in a semispherical groove of the bowl seat through the ball head shaft mounted at one end of the rotary inlet pipe. The rotary inlet pipe rotatably runs around the fixed inlet pipe under the support of the bowl seat. The stirring pipes are mounted horizontally on the two sides of the lower part of the rotary inlet pipe, and the two stirring pipes are symmetric by taking the center line of the rotary inlet pipe as the axis of symmetry. One end of each stirring pipe is vertically communicated with the rotary inlet pipe, and the opening of the other end of each stirring pipe is closed by a stop plate (6). The ends of the two stirring pipes close to the stop plates are respectively provided with at least one water distribution pipe. The two water distribution pipes have opposite water discharging directions.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present disclosure.

It will be understood that certain features and subcombinations are of utility and may be employed without reference to other features and subcombinations and are contemplated within the scope of the claims. Unless indicated otherwise, not all steps listed in the various figures need be carried out in the specific order described.

The disclosure claimed is:

1. A bearingless hydraulic rotary stirring water distributor comprising:
a rotary inlet pipe, two stirring pipes, water distribution pipes, a ball head shaft, a fixed inlet pipe, a bowl seat, and seal rings,
wherein:
the stirring water distributor is vertically mounted;
the fixed inlet pipe is vertically arranged and inserted into the rotary inlet pipe;
the fixed inlet pipe and the rotary inlet pipe are mechanically sealed through the seal rings therebetween;
the rotary inlet pipe is a vertically mounted pipe;
the rotary inlet pipe is vertically mounted in a semispherical groove of the bowl seat through the ball head shaft mounted at one end of the rotary inlet pipe;
the rotary inlet pipe rotatably runs around the fixed inlet pipe under the support of the bowl seat;
the two stirring pipes are mounted horizontally on two sides of a lower part of the rotary inlet pipe;
the two stirring pipes are symmetric over an axial line of the rotary inlet pipe;
one end of each stirring pipe is vertically communicated with the rotary inlet pipe, and an opening of the other end of each stirring pipe is closed by a stop plate; and
the two ends the two stirring pipes close to the stop plates are respectively provided with at least one water distribution pipe located on the same horizontal plane, and have opposite water discharging directions.

2. The bearingless hydraulic rotary stirring water distributor according to claim 1, wherein:
an axial line of the fixed inlet pipe and the axial line of the rotary inlet pipe coincide; and
a gap between the fixed inlet pipe and the rotary inlet pipe is sealed by the seal rings.

3. The bearingless hydraulic rotary stirring water distributor according to claim 1, wherein the water distribution pipes are perpendicular to the stirring pipes.

4. The bearingless hydraulic rotary stirring water distributor according to claim 1, wherein:
the ball head shaft is composed of a circular shaft and a ball head;
the circular shaft is fixed on the ball head through a welding manner, through threads, or through a one-time turning processing;
an outer diameter of the circular shaft and an inner diameter of the rotary inlet pipe are in an interference fit; and
an outer diameter of the ball head is smaller than an inner diameter of the semispherical groove of the bowl seat.

5. The bearingless hydraulic rotary stirring water distributor according to claim 1, wherein:
the rotary inlet pipe, the stirring pipes and the water distribution pipes are in communication with each other; and
water is fed into the rotary inlet pipe through the fixed inlet pipe and then discharged through the water distribution pipes.

6. The bearingless hydraulic rotary stirring water distributor according to claim 1, wherein each stirring pipe has more than one water distribution pipe.

7. The bearingless hydraulic rotary stirring water distributor according to claim 1, wherein a mounting vertical inclination angle between the axial line of the rotary inlet pipe and the axial line of the ball head shaft is smaller than 3 degrees.

8. The bearingless hydraulic rotary stirring water distributor according to claim 1, wherein the axial line of the fixed inlet pipe, the axial line of the rotary inlet pipe, and a center line of the semispherical groove of the bowl seat coincide.

9. The bearingless hydraulic rotary stirring water distributor according to claim 1, wherein a length of each stirring pipe, an inclination angle between each water distribution pipe and the horizontal plane, and a water discharging direction of each water distribution pipe are manipulated to achieve stirring effects.
